(19) United States
(12) Patent Application Publication
(10) Pub. No.: US 2020/0070768 A1
(43) Pub. Date: Mar. 5, 2020

(54) VEHICLE SEAT

(71) Applicant: TOYOTA JIDOSHA KABUSHIKI KAISHA, Toyota-shi (JP)

(72) Inventor: Kazuya MORI, Okazaki-shi (JP)

(73) Assignee: TOYOTA JIDOSHA KABUSHIKI KAISHA, Toyota-shi (JP)

(21) Appl. No.: 16/532,635

(22) Filed: Aug. 6, 2019

(30) Foreign Application Priority Data
Aug. 30, 2018 (JP) 2018-161140

(51) Int. Cl. B60R 21/231; B60R 21/207

(52) U.S. Cl. CPC B60R 21/23138; B60N 2002/5808; B60R 21/207

(57) ABSTRACT

A vehicle seat including a seat cushion and a seat back, the vehicle seat includes a front surface portion that structures a portion of a frame of the seat cushion, which is adapted to support buttocks of a passenger, the front surface portion is disposed at a front part of the vehicle seat, and a face of the front surface portion facing toward a front side of the vehicle sea; and an energy absorbing member that is provided along the face of the front surface portion, and the energy absorbing member is configured to irreversibly deform by being pushed toward a rear side of the vehicle seat.

### CROSS-REFERENCE TO RELATED APPLICATION

This application claims priority under 35 USC 119 from Japanese Patent Application No. 2018-161140 filed Aug. 30, 2018, the disclosure of which is incorporated by reference herein in its entirety.

### BACKGROUND

### Technical Field

The present disclosure relates to a vehicle seat.

### Related Art

Japanese Patent Application Laid-Open (JP-A) No. 2017-149331 discloses a passenger protecting device that reduces the injury degree of passengers who are seated in vehicle seats that are disposed so as to face one another in the front-rear direction of a vehicle. In the passenger protecting device disclosed in that document, at the time of a collision of the vehicle, by expanding a traversing airbag between vehicle seats that are disposed so as to face one another, the traversing airbag is interposed between the passengers who are seated in these vehicle seats. Due thereto, the knees of the passengers who are seated in the vehicle seats contacting one another can be suppressed.

### SUMMARY

At the time when a vehicle disposed with a vehicle seat that faces toward a rear side of the vehicle front-collides, or at the time when a vehicle disposed with a vehicle seat that faces toward a front side of the vehicle rear-collides, it may happen that the calves of the legs of the passenger seated in the vehicle seat will contact a seat cushion.

In view of the above-described circumstances, an object of the present disclosure is to provide a vehicle seat that can reduce the injury degree of the calves of the legs of a passenger at the time of a collision that is such that the calves are pushed against a distal end portion of a seat cushion.

A vehicle seat of a first aspect of the present disclosure has a seat cushion and a seat back, and the vehicle seat further has a front surface portion that structure a portion of a frame of the seat cushion, which is adapted to support buttocks of a passenger, the front surface portion is disposed at a front part of the vehicle seat, and a face of the front surface portion facing toward a front side of the vehicle seat; and an energy absorbing member that is provided along the face of the front surface portion, and, that is configured to irreversibly deform by being pushed toward a rear side of the vehicle seat.

In accordance with the vehicle seat of the first aspect, at the time when the vehicle collides at a front side thereof in a state in which the vehicle seat is facing toward a rear side of the vehicle, or at the time when the vehicle collides at a rear side thereof in a state in which the vehicle seat is facing toward a front side of the vehicle, the energy absorbing member is pushed by the legs of the passenger.

Due thereto, the energy absorbing member irreversibly deforms, between the legs of the passenger and the front surface portion of the frame of the seat cushion. As a result, the injury degree of the calves of the legs of the passenger can be reduced.

In a vehicle seat of a second aspect of the present disclosure, in the vehicle seat of the first aspect, a seat cushion pad is mounted to the frame of the seat cushion, and the energy absorbing member is formed integrally with the seat cushion pad.

In accordance with the vehicle seat of the second aspect, the energy absorbing member is formed integrally with the seat cushion pad. Due thereto, the mounting of the energy absorbing member can be completed simultaneously with the work of mounting the seat cushion pad to the frame of the seat cushion.

In a vehicle seat of a third aspect of the present disclosure, in the vehicle seat of the first aspect, the energy absorbing member is fixed to the face of the front surface portion.

In accordance with the vehicle seat of the third aspect, the energy absorbing member is fixed to the face of the front surface portion of the frame of the seat cushion. Due thereto, the mounted posture of the energy absorbing member with respect to the frame of the seat cushion can be stabilized.

In a vehicle seat of a fourth aspect of the present disclosure, in the vehicle seat of the first aspect, the energy absorbing member is an airbag that inflates in a case in which the passenger inertially moves toward a rear side of the vehicle seat, and at least a portion of the airbag after inflation is disposed along the face of the front surface portion.

In accordance with the vehicle seat of the fourth aspect, the airbag inflates at the time when the vehicle collides at a front side thereof in a state in which the vehicle seat is facing toward the rear side of the vehicle, or at the time when the vehicle collides at a rear side thereof in a state in which the vehicle seat is facing toward the front side of the vehicle, i.e., at the time when the passenger inertially moves toward the rear side of the vehicle seat. The airbag is pushed by the legs of the passenger. Due thereto, the airbag irreversibly deforms, between the legs of the passenger and the front surface portion of the frame of the seat cushion. As a result, the injury degree of the calves of the legs of the passenger can be reduced.

In a vehicle seat of a fifth aspect of the present disclosure, in the vehicle seat of the fourth aspect, a seat cushion pad is mounted to the frame of the seat cushion, the airbag is disposed between the frame of the seat cushion and the seat cushion pad, and a portion at a seat front side of the seat cushion pad is configured to inflate toward a seat upper side due to the airbag inflating.

In accordance with the vehicle seat of the fifth aspect, when the airbag inflates, the portion at the seat front side of the seat cushion pad bulges toward the seat upper side. In this structure, due to the airbag being inflated in a case in which the passenger inertially moves toward the front side of the vehicle seat, the buttocks of the passenger can be restrained by the front end portion of the seat cushion pad. Further, due to the airbag being inflated in a case in which the passenger inertially moves toward the rear side of the vehicle seat, the airbag is pushed by the legs of the passenger and the injury degree of the calves of the legs of the passenger can be reduced.

The vehicle seats of the respective aspects of the present disclosure have the excellent effect of being able to reduce the injury degree of the calves of the legs of a passenger at the time of a collision which is such that the calves are pushed-against the distal end portion of a seat cushion.

### BRIEF DESCRIPTION OF THE DRAWINGS

FIG. 1 is a partial sectional view showing a vehicle seat of a first embodiment from a seat transverse direction;

FIG. 2 is a cross-sectional view showing a front end portion of a seat cushion that is cut along line 2-2 of FIG. 1;

FIG. 3 is a cross-sectional view showing a vehicle seat of a second embodiment from a seat transverse direction, and shows a front end portion of a seat cushion in an enlarged manner; and

FIG. 4 is a cross-sectional view that corresponds to FIG. 3 and shows the vehicle seat of the second embodiment, and shows a state in which an airbag has inflated.

### DETAILED DESCRIPTION

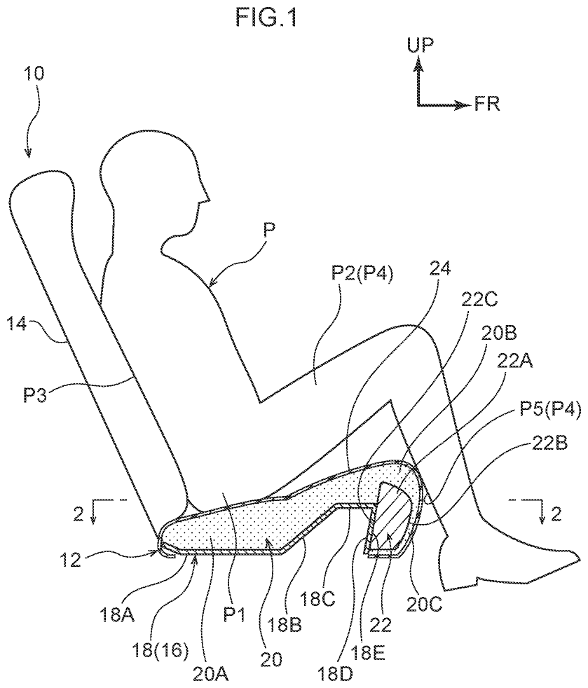

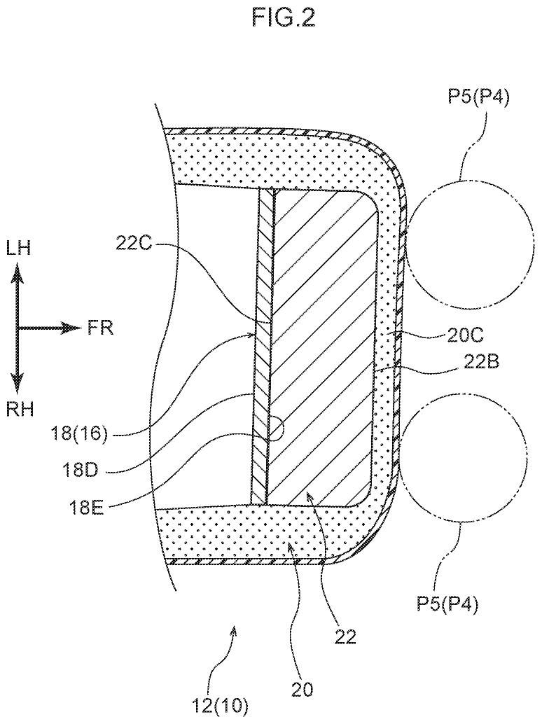

A vehicle seat 10 relating to a first embodiment of the present disclosure is described by using FIG. 1 and FIG. 2. Note that, in the following explanation, when description is given by using front-rear, left-right and up-down directions, they refer to the front-rear, the left-right, and the up-down directions as seen from a passenger who is seated in the vehicle seat 10. Further, arrow FR that is shown appropriately in the respective drawings indicates a seat forward direction, arrow UP indicates a seat upward direction, arrow RH indicates a seat rightward direction, and arrow LH indicates a seat leftward direction. Further, the left-right direction coincides with a seat transverse direction.

As shown in FIG. 1, the vehicle seat 10 of the present embodiment has a seat cushion 12 that supports buttocks P1 and a femoral region P2 of a passenger P (seated passenger), and a seatback 14 that supports a back portion P3 of the passenger P. The vehicle seat 10 of the present embodiment is provided in a cabin of a self-driving vehicle. The seat front side of the vehicle seat 10 is fixed in a state of facing toward a rear side of the vehicle. Note that there may be a structure in which the seat front side of the vehicle seat 10 is made to face toward a front side of the vehicle due to the vehicle seat 10 being rotated. Further, the vehicle seat 10 of the present embodiment can also be applied to manually-driven vehicles.

The seat cushion 12 has a panel member 18 that structures a portion of a frame 16 of the seat cushion 12, a seat cushion pad 20 that is mounted to the frame 16 of the seat cushion 12, and an energy absorbing member 22 that is joined to the panel member 18.

The panel member 18 is formed by using a metal plate such as a steel plate or the like. This panel member 18 has a bottom surface portion 18A that extends in the front-rear direction and the seat transverse direction at a position facing, in the up-down direction, the buttocks P1 of the passenger P seated on the seat cushion 12. Further, the panel member 18 has an inclined surface portion 18B that extends from a front end of the bottom surface portion 18A so as to incline toward the upper side while heading toward the seat front side. Moreover, the panel member 18 has a peak surface portion 18C that extends from a front end of the inclined surface portion 18B toward the seat front side and the peak surface portion 18C is substantially parallel to the front-rear direction and the transverse direction of the vehicle seat 10. Further, the panel member 18 has a front surface portion 18D that extends toward a lower side from a front end of the peak surface portion 18C and a face 18E faces toward a front side of the vehicle seat 10. In the present embodiment, the front surface portion 18D is inclined slightly toward a rear side of the vehicle seat 10 while heading toward the lower side.

The seat cushion pad 20 is formed by using a soft polyurethane foam or the like. The seat cushion pad 20 has a main portion 20A, which is disposed along upper surfaces of the bottom surface portion 18A, the inclined surface portion 18B and the peak surface portion 18C of the panel member 18. The seat cushion pad 20 further has an upper side covering portion 20B, which extends toward the seat front side from a front end of the main portion 20A and covers an upper side portion 22A of the energy absorbing member 22 that is described later. Further, the seat cushion pad 20 has a front side covering portion 20C that extends toward a lower side from a front end of the upper side covering portion 20B and covers a seat front side portion 22B of the energy absorbing member 22. Note that a portion, which can be seen by the passenger P, of the above-described seat cushion pad 20 is covered by a skin material 24.

The energy absorbing member 22 is formed by using a material that is harder than the seat cushion pad 20, and is formed in the shape of a rectangular block whose length direction is along the seat transverse direction. The energy absorbing member 22 is formed by ribs or a honeycomb structural body that is formed from a hard urethane resin or a foamed polypropylene resin.

A rear side surface 22C of the energy absorbing member 22 is joined via an adhesive or the like to the seat front side face 18E of the front surface portion 18D of the panel member 18. Due thereto, the energy absorbing member 22 is fixed to the panel member 18. Further, in the state in which the energy absorbing member 22 is fixed to the panel member 18, the upper side portion 22A projects out toward an upper side with respect to the peak surface portion 18C of the panel member 18.

Operation and effects of the present embodiment are described next.

When the vehicle 10 collides at a front side thereof in a state in which the above-described vehicle seat 10 faces toward a rear side of the vehicle, the passenger P who is seated in the vehicle seat 10 inertially moves toward the seat rear side (the vehicle front side). Due thereto, the back portion P3 of the passenger P pushes the seatback 14, and legs P4 (calves P5) of the passenger P push the energy absorbing member 22 via the front side covering portion 20C of the seat cushion pad 20. Due thereto, the energy absorbing member 22 deforms between the legs P4 of the passenger P and the front surface portion 18D of the panel member 18. As a result, the injury degree of the calves P5 of the passenger P can be reduced. In the present embodiment, the energy absorbing member 22 irreversibly deforms, between the legs P4 and the front surface portion 18D. By providing this energy absorbing member 22 that cannot be restored from its deformed state in this way, the kinetic energy of the legs P4 of the passenger P can be absorbed effectively. Due thereto, the injury degree of the calves P5 of the passenger P can be reduced effectively as compared with a structure that merely increases the thickness of the front side covering portion 20C of the seat cushion pad 20.

Note that the injury degree of the calves P5 of the passenger P can be effectively reduced in the same way also in a case in which the vehicle collides at a rear side thereof in a state in which the vehicle seat 10 is facing toward a front side of the vehicle.

Further, in the present embodiment, the energy absorbing member 22 is fixed via an adhesive to the front surface portion 18D of the panel member 18. Due thereto, the mounted posture of the energy absorbing member 22 with respect to the panel member 18 can be stabilized.

The energy absorbing member 22 and the seat cushion pad 20 may be made to be integral by insert molding or the like. In this structure, the mounting of the energy absorbing member 22 can be completed simultaneously with the work of mounting the seat cushion pad 20 to the frame 16 (the panel member 18 and the like) of the seat cushion.

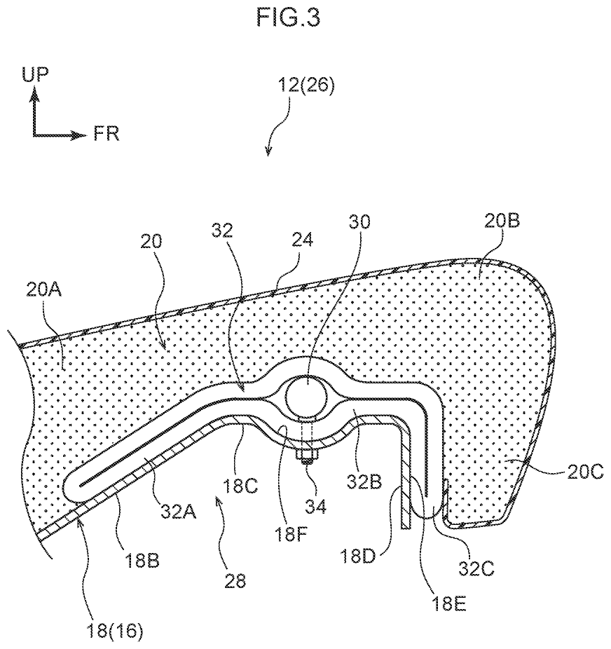

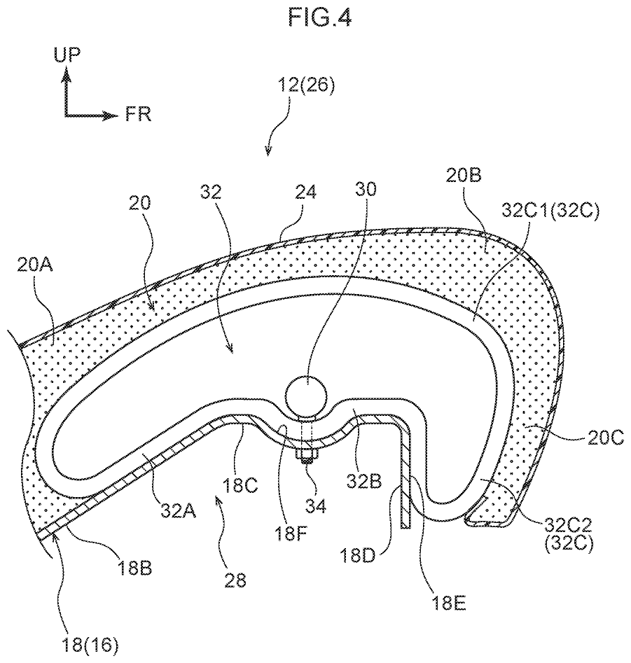

A vehicle seat 26 relating to a second embodiment of the present invention is described by using FIG. 3 and FIG. 4. Note that, at the vehicle seat 26 relating to the second embodiment, members and portions corresponding to those of the vehicle seat 10 relating to the above-described first embodiment are denoted by the same reference numerals as the corresponding members and portions of the vehicle seat 10 relating to the first embodiment, and there are cases in which description thereof is omitted.

As shown in FIG. 3 and FIG. 4, the vehicle seat 26 of the present embodiment has the feature that an airbag device 28 is provided instead of the energy absorbing member 22 (see FIG. 1) of the vehicle seat 10 relating to the first embodiment.

The airbag device 28 is provided between the panel member 18 and the seat cushion pad 20. This airbag device 28 is structured to include an inflator 30 that generates gas by being operated, and an airbag 32 that serves as an energy absorbing member and that inflates due to gas generated by the inflator 30 being supplied to an interior of the airbag 32.

The inflator 30 is disposed at a substantially central portion in the front-rear direction and the seat transverse direction of the airbag device 28. A fixing member 34 (stud bolt) for fixing the airbag device 28 to the panel member 18 is provided integrally with the inflator 30. Note that a cavity 18F is formed at the peak surface portion 18C of the panel member 18 at a region with which the fixing member 34 is engaged.

The airbag 32 is formed in a rectangular shape in the state before gas is supplied to the interior thereof (the state in which the airbag 32 is folded-up). Further, in the state in which the airbag device 28 is fixed to the panel member 18 via the inflator 30, a rear side portion 32A in the seat front-rear direction of the airbag 32 is disposed along an upper surface of the inclined surface portion 18B of the panel member 18. Further, a front-rear direction central portion 32B of the airbag 32 is disposed along an upper surface of the peak surface portion 18C of the panel member 18. A portion, which corresponds to the inflator 30, at the front-rear direction central portion 32B of the airbag device 28 bulges-out toward the upper side. A cavity 20D is formed at the main portion 20A of the seat cushion pad 20 so as to correspond to this bulge at the airbag device 28. Further, a seat front side portion 32C of the airbag 32 is disposed along the seat front side face 18E of the front surface portion 18D of the panel member 18.

Operation and effects of the present embodiment are described next.

When the vehicle collides at a front side thereof in a state in which the above-described vehicle seat 26 faces toward the rear side of the vehicle, the inflator 30 is operated. Then, due to the gas generated by the inflator 30 being supplied to the interior of the airbag 32, the airbag 32 inflates as shown in FIG. 4.

The seat rear side portion 32A, the front-rear direction central portion 32B, and an upper portion 32C1 of the seat front side portion 32C of the airbag 32 that has inflated push, toward the upper side, the seat front side portion of the main portion 20A and the upper side covering portion 20B of the seat cushion pad 20. As a result, the seat front side portion of the seat cushion pad 20 bulges toward the seat upper side. Further, a lower portion 32C2 of the seat front side portion 32C of the airbag 32 that has inflated is disposed along the seat front side face 18E of the front surface portion 18D of the panel member 18.

The passenger P who is seated at the vehicle seat 10 moves inertially toward the seat rear side, and the legs P4 (the calves P5) of the passenger P push the front side portion 32C of the airbag 32 via the front side covering portion 20C of the seat cushion pad 20. Due thereto, the lower portion 32C2 of the seat front side portion 32C of the airbag 32 deforms between the legs P4 and the front surface portion 18D. As a result, the kinetic energy of the legs P4 of the passenger P is absorbed, and the injury degree of the calves P5 of the passenger P can be reduced.

In the vehicle seat 26 of the present embodiment, due to the airbag 32 inflating, the seat front side portion of the seat cushion pad 20 bulges toward the seat upper side. Therefore, at the time when the vehicle collides at a rear side thereof in the state in which the vehicle seat 26 is facing toward the rear side of the vehicle, due to the inflator 30 being operated, the buttocks P1 of the passenger P who has moved inertially toward the seat front side can be restrained by the bulged-out front end portion of the seat cushion pad 20. As a result, the occurrence of the submarine phenomenon can be suppressed.

Note that, also in a case in which the vehicle collides at a rear side thereof in a state in which the vehicle seat 26 is facing toward the front side of the vehicle, similarly, the injury degree of the calves P5 of the passenger P can be effectively reduced. Further, also in a case in which the vehicle collides at a front side thereof in a state in which the vehicle seat 26 of the present embodiment is facing toward the front side of the vehicle, similarly, the buttocks P1 of the passenger P who has moved inertially toward the seat front side can be restrained by the bulged-out front end portion of the seat cushion pad 20.

Note that an example is described in which the vehicle seat 26 of the present embodiment is structured such that the seat front side portion of the seat cushion pad 20 bulges toward the seat upper side due to the airbag 32 inflating. However, the present disclosure is not limited to this. For example, there may be a structure in which an airbag that is disposed only along the front surface portion 18D of the panel member 18 is provided, and the seat front side portion of the seat cushion pad 20 does not bulge toward the seat upper side.

Although embodiments of the present disclosure have been described above, the present disclosure is not limited to the above, and can, of course, be implemented by being modified in various ways other than the above within a scope of the present disclosure.

What is claimed is:

1. A vehicle seat including a seat cushion and a seat back, the vehicle seat comprising:
a front surface portion that structures a portion of a frame of the seat cushion, which is adapted to support buttocks of a passenger, the front surface portion being disposed at a front part of the vehicle seat, and a face of the front surface portion facing toward a front side of the vehicle seat; and
an energy absorbing member that is provided along the face of the front surface portion, and the energy absorbing member is configured to irreversibly deform by being pushed toward a rear side of the vehicle seat.

2. The vehicle seat of claim 1, wherein:
a seat cushion pad is mounted to the frame of the seat cushion, and
the energy absorbing member is formed integrally with the seat cushion pad.

3. The vehicle seat of claim 1, wherein the energy absorbing member is fixed to the face of the front surface portion.

4. The vehicle sea of claim 1, wherein:
the energy absorbing member is an airbag that inflates in a case in which the passenger inertially moves toward the rear side of the vehicle seat, and
at least a portion of the airbag after inflation is disposed along the face of the front surface portion.

5. The vehicle seat of claim 4, wherein:
a seat cushion pad is mounted to the frame of the seat cushion,
the airbag is disposed between the frame and the seat cushion pad, and
a portion at a seat front side of the seat cushion pad is configured to bulge toward a seat upper side due to the airbag inflating.
